(19) United States
(12) Patent Application Publication
(10) Pub. No.: US 2007/0281661 A1
(43) Pub. Date: Dec. 6, 2007

(54) Method for determining if a mobile unit is transient

(76) Inventor: Kenneth W. Del Signore, North Aurora, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/444,551

(22) Filed: May 31, 2006

(51) Int. Cl. H04M 11/04

(52) U.S. Cl. 455/404.2

(57) ABSTRACT

The present invention provides a method for determining if a mobile unit is transient. An MSC receives a location event including a cell site and a time from a mobile unit. The MSC compares the time of the location event with the time of a previous location event for the current cell to get a time difference. If the time difference is greater than the predetermined value, the MSC indicates that the mobile unit is transient.

### FIELD OF THE INVENTION

The present invention relates generally to mobile communication systems, and more particularly to a method for identifying transient mobile units.

### BACKGROUND OF THE INVENTION

One exceptional feature of mobile units, sometimes referred to as cell phones, is the ability to place and receive calls from diverse geographic locations. The ability for mobile units to roam to other cellular sites allows mobile units to be used virtually ubiquitously. Mobile units are also able to hand off from a current base station to a new base station when the mobile unit is moving from the cell of the first base station to the cell of the second base station.

Cellular systems can collect the information about transient mobile units. This information is useful to systems that measure vehicle traffic flow information using cellular phone position and velocity information. These systems attempt to measure real time traffic flow and can alert users of adverse traffic conditions, allowing them to avoid such conditions.

Mobile units are an ideal probe of vehicle speed for several reasons. First, they are found in many vehicles. Second, position and velocity information can be obtained from them. Third, the information can easily be collected at a central computing system.

However, to date, these systems have not had widespread success. A fundamental problem is that roadways pass through areas with high concentrations of non vehicle borne cellular phones, and the measurement system cannot differentiate mobile units that are in vehicles on the roadway from mobile units that are not. A good example is an office building next to a roadway. There may be hundreds of mobile units in the office building, while at any given time there may be none or only very few phones nearby on the roadway. These non-vehicle borne mobile units thus represent a “background noise” to the measurement of vehicle speed on the nearby roadway.

One approach undertaken has been to determine which mobile units are vehicle-borne by measuring the velocity of the phone. A second approach has been to determine which mobile units are proximal to known roadways. However, both of these approaches are limited. The first can produce faulty results when there is a traffic jam, since the mobile units are not moving due to the traffic jam, which is the exact situation that this approach is supposed to determine. The second approach is limited by the resolution of location determination. Further, many who are not transient, such as those who are located in an office adjacent to a highway, would be counted as mobile-borne mobile units due to their proximity to the highway.

Therefore, a need exists for a method of accurately distinguishing between transient vehicle borne and non-transient non-vehicle borne mobile units.

### BRIEF SUMMARY OF THE INVENTION

The present invention provides a method for determining if a mobile unit is transient. When a mobile unit has an interaction with a Mobile Switching Center (MSC), an exemplary embodiment of the present invention provides a way to determine if the mobile unit is currently transient or non-transient.

Each mobile unit that has registered with an MSC in the recent past will have an associated paging record, commonly referred to as an adaptive paging database record. Each paging record includes a cell field and a last accessed field. The cell field includes an entry for each cell that has been accessed by the mobile unit within the predetermined time period. The last accessed field includes an entry that indicates the last time that the associated mobile unit was located within the corresponding cell, which is preferably updated each time the mobile unit sends a message to the MSC.

In accordance with an exemplary embodiment, the MSC examines a mobile unit when the mobile unit interacts with the MSC. The time difference between the current interaction and the last interaction at the current cell site as stored in the database correlates highly with whether that mobile unit is currently transient.

Most mobile units spend large portions of each day in only a few locations, typically with low mobility. One example is a user of a mobile unit who drives to work in the morning, spends the day there, and then drives home at night. Due to time-based autonomous registrations, which are variable automatic interactions between the mobile unit and the MSC, the timestamps of the cells that cover the workplace and home of the mobile unit will tend to be more recent. When the difference between the current interaction and the last interaction is greater than a predetermined value, the mobile unit is more likely to have been in the same location for some time, and thus less likely to be in a vehicle.

Each time a mobile unit interacts with the MSC, the MSC updates the paging record for the mobile unit. An interaction includes any message sent from the mobile unit to the MSC, including registration messages, handoff messages, and any other messages sent from the mobile unit to the MSC via a base station.

The present invention allows a communication system to predict which mobile units are transient, and to therefore use this information for other beneficial purposes. For example, knowing which mobile units are transient allows the communication system to determine the velocity of mobile units, thereby being able to determine traffic times and traffic patterns. This information can also be used to determine optimal traffic patterns by utilizing traffic time information.

### BRIEF DESCRIPTION OF THE SEVERAL VIEWS OF THE DRAWINGS

FIG. 1 depicts a wireless communication system including transient and non-transient mobile units in accordance with an exemplary embodiment of the present invention.

FIG. 2 depicts a paging record for a mobile unit in accordance with an exemplary embodiment of the present invention.

FIG. 3 depicts a flowchart of a method for determining which mobile units are transient in a wireless communication system in accordance with an exemplary embodiment of the present invention.

### DETAILED DESCRIPTION OF THE INVENTION

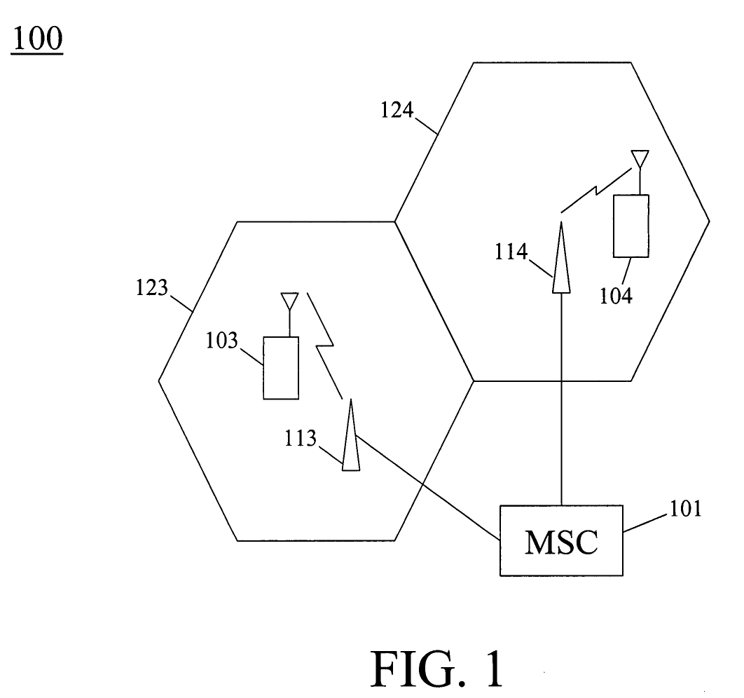

The present invention can be better understood with reference to FIGS. 1 through 3. FIG. 1 depicts a wireless communication system 100 including transient and non-transient mobile units in accordance with an exemplary embodiment of the present invention.

Communication system 100 includes a Mobile Switching Center (MSC) 101, a transient mobile unit 103, a non-transient mobile unit 104, a first base station 113, and a second base station 114. Base station 113 is associated with an area defined by cell 123, and base station 114 is associated with an area defined by cell 124. Base stations 113 and 114 transmit and receive signals to and from mobile units located within their respective cells. In the exemplary embodiment depicted in FIG. 1, mobile unit 123 is located within a vehicle and mobile unit 104 is on the person of a user who is not within a vehicle. As used herein, the term “transient” refers to a mobile unit that is being transported in a vehicle. When a mobile unit does not spend a large fraction of its time in a specific location, the mobile unit can be considered to be transient.

MSC 101 controls base stations 113 and 114. In a typical cellular communication system, an MSC controls a plurality of base stations, but only two base stations are depicted in FIG. 1 for clarity.

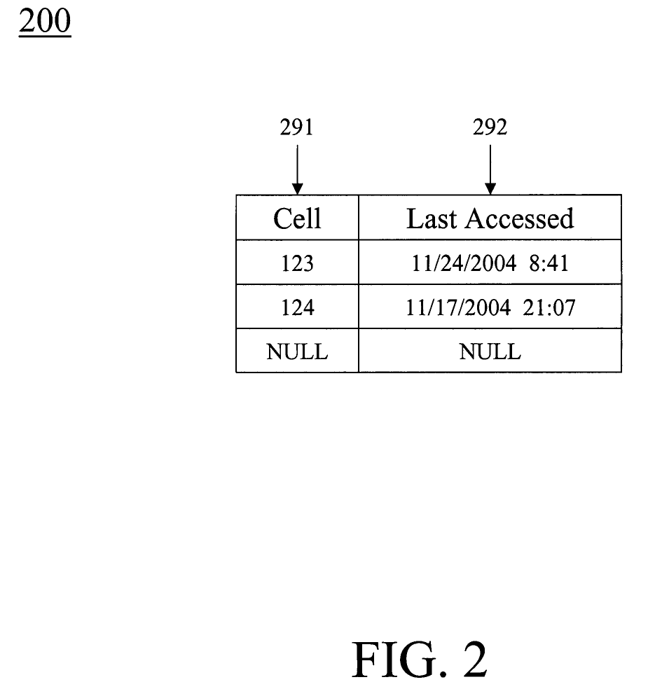

FIG. 2 depicts a paging record 200 for a mobile unit in accordance with an exemplary embodiment of the present invention. Each mobile unit that has registered with the MSC in the recent past will have an associated paging record. Paging record 200 includes cell field 291 and last accessed field 292. A paging database includes a plurality of paging records, preferably one record for each mobile unit interfacing with MSC 101.

Cell field 291 includes an entry for each cell in which a mobile unit has transmitted a message. Each cell field preferably includes the cell number of a cell, or a NULL value if there is no cell entry.

Last accessed field 292 includes an entry that indicates the last time that the associated mobile unit sent a message in the corresponding cell. In an exemplary embodiment, each last accessed field is updated each time the mobile unit sends a message to the MSC while within a cell.

In an exemplary embodiment, a nightly audit expires cells that are older than a provisionable limit. In an exemplary embodiment, the provisionable limit is set to twenty one days, although any appropriate number of days can be used. A record for a mobile unit is preferably deleted if all cell entries are expired. If the record still includes valid cell entries, the record for the mobile unit will continue to be stored at the MSC. Thus, the record remains as long as the mobile unit visits the MSC.

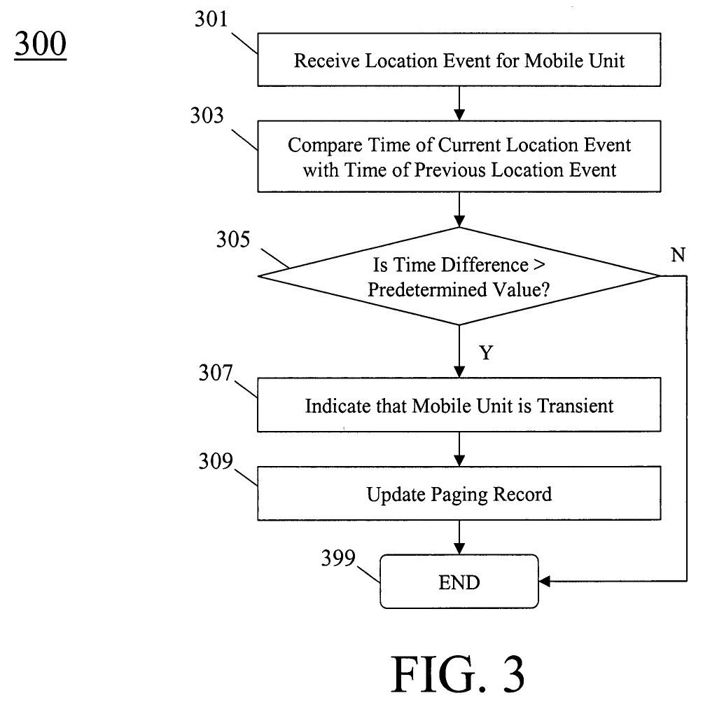

FIG. 3 depicts a flowchart 300 of a method for determining which mobile units are transient in a wireless communication system in accordance with an exemplary embodiment of the present invention.

MSC 101 receives (301) a location event from mobile unit 103. In an exemplary embodiment, a location event includes any message sent from the mobile unit to MSC 101, such as registration messages and handoff messages. A location event preferably also includes a time-based registration strategy whereby a mobile unit will re-register with MSC 101 at fixed time intervals if no other activity has occurred.

MSC 101 compares (303) the time of the current location event with the time of the previous location event. The premise is that most mobile unit users spend large portions of each day in only a few locations with low mobility. One example is a user who drives to work in the morning, spends the day there, and then drives home at night. Due to time based automatic registrations, the timestamps of the cells that cover this mobile unit while at work or home will tend to be more recent. When a recent timestamp is observed, the mobile unit is more likely to have been in the same location for some time, and thus less likely to be in a vehicle.

The MSC determines (305) if the time difference between the current location event and the previous location event is greater than a predetermined value. In accordance with an exemplary embodiment, the determination is made when a mobile unit interacts with MSC 101. Using the time difference between the current location event and the stored location event and comparing to a threshold value allows you to determine, with a high probability, that the mobile unit is in a transient state. If the time difference is not greater than the predetermined value, the mobile unit is considered to be non-transient and the process ends (399). This is due to the fact that a mobile unit that has had an interaction with MSC 101 within a time period less than the predetermined value is more likely to be non-transient.

If the time difference is greater than the predetermined value as determined at step 305, the MSC indicates (307) that the mobile unit is a transient unit. Having a time difference greater than the predetermined value indicates that the mobile unit has not been at this cell site for a while, which indicates that the mobile unit is currently transient.

The MSC updates (309) the paging record with the information from the current location event. In an exemplary embodiment, MSC 101 accesses the paging record associated with the mobile unit and determines if an entry exists for the current cell. If an entry exists for the current cell, the entry is overwritten with the current date and time. If an entry does not exist for the current cell, MSC 101 creates a new entry for the current cell and writes the date and time extracted from the message into the last accessed field. The process then ends (399).

While this invention has been described in terms of certain examples thereof, it is not intended that it be limited to the above description, but rather only to the extent set forth in the claims that follow.

I claim:

1. A method for determining if a mobile unit is transient comprising:
receiving a location event from a mobile unit, the location event including a time of the location event;
comparing the time of the location event with the time of a previous location event to get a time difference;
determining if the time difference is greater than a predetermined value; and
if the time difference is greater than the predetermined value, indicating that the mobile unit is transient.

2. A method for determining if a mobile unit is transient in accordance with claim 1, wherein the location event is a message sent from the mobile unit to a Mobile Switching Center.

3. A method for determining if a mobile unit is transient in accordance with claim 1, wherein the location event is a registration message sent from the mobile unit to a Mobile Switching Center.

4. A method for determining if a mobile unit is transient in accordance with claim 1, wherein the location event is a handoff message sent from the mobile unit to a Mobile Switching Center.

5. A method for determining if a mobile unit is transient in accordance with claim 1, wherein the location event is a time-based registration message sent from the mobile unit to a Mobile Switching Center.

6. A method for determining if a mobile unit is transient in accordance with claim 1, the method further comprising the step of updating a paging record with the information from the current location event.

7. A method for determining if a mobile unit is transient in accordance with claim 1, wherein the predetermined value is twenty four hours.

8. A method for determining if a mobile unit is transient in accordance with claim 5, wherein the predetermined value is greater than a length of an autonomous registration message.

9. A method for determining if a mobile unit is transient in accordance with claim 1, the method further comprising the step of storing an identifier of the mobile unit in a transient mobile unit database if the time difference is greater than the predetermined value.

10. A method for determining real-time traffic conditions utilizing transient mobile units, the method comprising:
receiving a location event from a mobile unit, the location event including a time of the location event;
comparing the time of the location event with the time of a previous location event to get a time difference;
determining if the time difference is greater than a predetermined value;
if the time difference is greater than the predetermined value, indicating that the mobile unit is transient; and
storing information pertaining to the mobile unit.

11. A method for determining real-time traffic conditions utilizing transient mobile units in accordance with claim 10, wherein the step of storing information pertaining to the mobile unit comprises storing the velocity of the mobile unit.

12. A method for determining real-time traffic conditions utilizing transient mobile units in accordance with claim 10, determining a traffic time utilizing the velocity of the mobile unit.

13. A method for determining real-time traffic conditions utilizing transient mobile units, the method comprising:
retrieving information pertaining to a plurality of transient mobile units; and
utilizing the information pertaining to the plurality of transient mobile units to determine real-time traffic conditions.

14. A method for determining real-time traffic conditions utilizing transient mobile units in accordance with claim 13, wherein the information pertaining to a plurality of transient mobile units comprises the velocity of each of the plurality of transient mobile units.

15. A method for determining real-time traffic conditions utilizing transient mobile units in accordance with claim 13, the method further comprising the step of utilizing the information pertaining to the plurality of transient mobile units to determine an optimal route of travel from a first location to a second location.
